(19) United States
(12) Patent Application Publication
(10) Pub. No.: US 2002/0148410 A1
(43) Pub. Date: Oct. 17, 2002

(54) Temperature control system

(76) Inventor: David A. Thomas, Colorado Springs, CO (US)

Correspondence Address: RICK MARTIN, PATENT LAW OFFICES OF RICK MARTIN, PC, 416 COFFMAN STREET, LONGMONT, CO, 80501, US

(21) Appl. No.: 10/123,619

(22) Filed: Apr. 15, 2002

Related U.S. Application Data
(60) Provisional application No. 60/283,849, filed on Apr. 14, 2001.

(51) Int. Cl. A01K 1/03

(52) U.S. Cl. 119/452

(57) ABSTRACT

A portable, climate controlled, pet enclosure for hermit crabs and the like features an ice chest which receives a temperature controlled pet enclosure. Cigarette lighter DC power and/or a house-current to low-voltage adapter powers a control circuit and heating element on the top of the pet enclosure. By placing a cold substance, such as ice in the ice chest, the desired temperature is maintained in the pet enclosure when the ambient temperature is either too warm or too cold for the pet. Other features include a cool-to-the-touch heater grill, a simple humidifier, and a temperature sensor reflector.

### CROSS REFERENCE APPLICATIONS

This application is a non-provisional application claiming the benefits of provisional application No. 60/283,849 filed Apr. 14, 2001.

### FIELD OF INVENTION

The present invention relates to portable, temperature controlled enclosures useful for transporting pets including reptiles in vehicles.

### BACKGROUND OF THE INVENTION

This invention is applicable in many situations where the temperature in an enclosure must be maintained within a range that is sometimes cooler and sometimes warmer than that of the external environment.

There are a number of products on the market whose purpose is to increase the temperature of an enclosure, such as a pet container containing a pet. Some products screw into a light bulb socket. Others are affixed to the bottom of the pet container with adhesive. Still others look like a rock and are placed in the pet container with the animal. They may or may not be thermostatically controlled. No known product is designed to be powered by the 12-volt electrical system of an automobile. No known systems are designed to remove heat from the enclosure in an excessively warm automobile.

There are a number of approaches to the problem of providing either heating or cooling, as needed. One approach would be to use the technology used by thermoelectric coolers, commonly used in electric ice-chests. With this technology, the device will either heat or cool, depending upon the polarity of the DC power applied to its mechanism. It would be easy to solve this problem using that technology, by adding an electronic control circuit to apply either heat or cooling as needed, to maintain the desired temperature. The drawback to this approach is the high cost of the technology.

What is needed is an inexpensive enclosure, with means to heat or cool its interior as needed to maintain a desired temperature. For some applications, it is further desirable for this enclosure to be portable.

### SUMMARY OF THE INVENTION

The primary aspect of the present invention is to provide an enclosure having a temperature controller and a cooling mechanism such as an ice chest to control a temperature in all the extremes found in a parked or moving vehicle. The present invention is directed to a method and apparatus of providing a temperature-controlled enclosure that is of minimum cost using an ice chest and a small electrically powered heater preferably powered by a 12 volt DC source.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

FIG. 1 is a cross-section of an exemplary embodiment of this invention (not necessarily limited to pet containers in automobiles).

FIG. 2 is a perspective view of this same embodiment.

FIG. 3 is a front-view drawing of a typical pet container 13, fitted with an electronically controlled, 12-volt heater unit 29, which was constructed for this exemplary embodiment.

FIG. 4 is a drawing of this same pet container 13, tilted to show how the heater element housing 32 of the electronically controlled heater unit 29 fits in the access-hole 14 in the lid of the pet container 13.

FIG. 5 is a cross-section, showing an embodiment 50 suitable for traveling with a small pet in an automobile.

FIG. 6 shows an embodiment of this invention that could be sold very inexpensively, if the customers provide their own ice chest 20, which is shown in FIG. 7.

FIG. 7 is a cross-section showing the embodiment depicted in FIG. 6, with the customer's ice chest 20, ready for use.

FIG. 8 shows an ice chest liner 38 which may be used with certain embodiments of the outer (cold) chamber 2. The ice chest lid 21 is not shown.

FIG. 9 is a perspective view of pet container assembly 39, which is the preferred embodiment. It shows how the front wall 42 of pet container insulator 22 may be folded in half, or folded completely down out of the way, for viewing of the pet. FIG. 9 also shows an embodiment of the humidifier assembly 43, in a typical location within the pet container. FIG. 9 also shows the heater unit 29. Cord 10 and plug 11 are not shown.

FIG. 10 is a close-up perspective view of the humidifier assembly 43.

FIG. 11 is a rear view embodiment 29 of electronically controlled heater unit 29.

FIG. 12 is a perspective view from underneath, of this same electronically controlled heater unit 29.

FIG. 13 is a front view of embodiment 29 of heater unit 29, that shows the indicator light 19.

FIG. 14 is a schematic diagram of embodiment 1400 of the control circuit.

FIG. 15 is a schematic diagram of the preferred embodiment of the control circuit 17.

FIGS. 16 to 20 are a flow chart which describes the firmware/software logic 1600 used in microprocessor U2, in the preferred embodiment of control circuit 17.

FIG. 21 is a graph which depicts the nonlinear heater control response, providing higher gain when more heating power is needed. This nonlinear response also helps keep the light from flickering, when heating element 4 is operating at low levels.

FIG. 22 is a perspective view from underneath, of a later embodiment of the heater unit 2200. This embodiment uses a green LED (indicator light 19) and a separate red LED (red warning light 37), which simplifies the control circuitry. FIG. 22 shows simple heater grill 40. FIG. 22 also shows the configuration of the temperature sensor 5, supported by temperature sensor tube 36. Also shown is an embodiment of temperature sensor reflector 24 with the cutaway embodiment of infrared feedback hole 25. Cord 10 and plug 11 are not shown.

FIG. 23 is a perspective view from underneath, of a preferred embodiment of embodiment of heater unit 2300. It shows the preferred embodiment of heater grill 26 and heater element housing 320. Cord 10 and plug 11 are not shown.

FIG. 24 is a cross-section of another embodiment of heater unit 2400. It shows heating element 4 suspended by bracket 28, so that it is entirely within the pet container, rather than partially within heater control housing 6.

FIG. 24 also shows an embodiment of temperature sensor reflector 45 with round infrared feedback hole 44.

### DETAILED DESCRIPTION OF PREFERRED EMBODIMENT

List of Reference Numerals

This section lists the reference numerals used in the drawings. The same numeral is used for a given part in every drawing in which it is found.

1. Inner (warm) chamber (interior storage space)

2. Outer (cold) chamber 3. Cold substance (thermal sink), such as ice

4. Heating element (which may be a light bulb)

5. Temperature sensor

6. Housing for heater control

7. Lid

8. Outer insulating wall

9. Inner wall—may or may not be insulated, depending upon application (vertical interior wall—closed loop)

10. Cord

11. Cigarette lighter male plug

12. Pet container lid

13. Pet container

14. Access hole in pet container lid

15. Reflector

16. Vent hole

17. Control circuit

18. Temperature adjustment screw

19. Indicator light

20. Ice chest

21. Ice chest lid

22. Pet container insulator

23. Transformer (house-current to low-voltage power converter)

24. Temperature sensor reflector

25. Cutaway embodiment of infrared feedback hole

26. Heater grill

27. Fins

28. Bracket

29. Heater unit

30. Wicking element

31. Water container

32. Heater element housing

33. Wick attachment

34. Water container lid

35. Water container attachment

36. Temperature sensor tube

37. Red warning light

38. Ice chest liner

39. Pet Container Assembly

40. Simple heater grill

41. Wicking element hole

42. Hinged front wall of pet container insulator

43. Humidifier assembly

44. Round infrared feedback hole

45. Temperature sensor reflector

50. Temperature control system—exemplary embodiment

100. Temperature control system—exemplary embodiment

200. Pet container assembly

320. Heater housing 700. Temperature control system—preferred embodiment

800. Temperature control system with ice chest liner

1400. Control circuit

1600. Firmware/Software logic

### DESCRIPTION OF GENERIC INVENTION

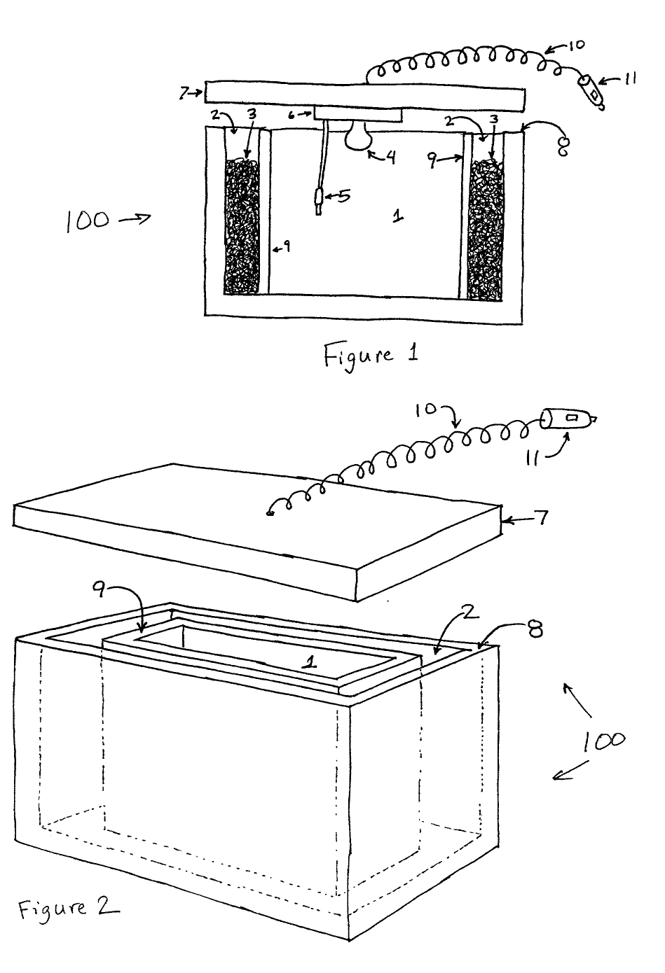

FIG. 1 is a cross-section of an exemplary embodiment 100 of this invention (not necessarily limited to pet containers in automobiles). FIG. 2 is a perspective view of this same embodiment. In its most basic form, this embodiment comprises an inner enclosure, an outer enclosure, and a temperature-controlled heat source in the inner enclosure. Within the inner enclosure is the inner (warm) chamber 1. The temperature in the inner chamber 1 is maintained at a preset temperature by heating element 4. Temperature sensor 5 works in conjunction with control circuit 17 to control the function of heating element 4 to maintain the desired temperature. Cigarette lighter plug 11 and cord 10 supply power to heating element 4, and control circuit 17. Housing 6 encloses control circuit 17, shown in FIG. 11.

Between the inner and outer enclosures is the outer (cold) chamber 2. Within this outer chamber 2, a cold substance (thermal sink) 3, such as ice is placed. Inner wall 9 separates the inner chamber 1 from the outer chamber 2. Inner wall 9 may or may not be insulated. Outer insulating wall 8 encloses all four sides and the bottom of the embodiment. Lid 7 encloses the top of both the inner and outer chambers, and thus, the entire embodiment.

### Operation of Generic Invention

See FIGS. 1 and 2. The essence of embodiment 100 is to have a heated inner chamber 1 inside of a cooled outer chamber 2. The heating element 4 in the inner chamber 1 is controlled by a thermostat or other control device. The outer chamber 2 is cooled by placing a cold substance (thermal sink) 3, such as ice into it. The purpose of the thermal sink is to absorb heat that would otherwise be radiated from the external environment into the inner enclosure. This provides a simple, inexpensive means of regulating the temperature in the inner chamber 1 when the environment may be either hotter or colder than the temperature desired in the inner chamber 1.

In the example in the drawing, heating element 4 is powered by electricity transmitted via cord 10 and cigarette lighter plug 11. The drawing shows plug 11 to be of the type for plugging into the cigarette lighter of a car. However plug 11 could be any type of plug, suitable for any type of electricity.

In the example in the drawing, temperature sensor 5 and control circuit 17 (not shown—housed in housing 6) determine the amount of power that heating element 4 is to radiate into the inner chamber 1. Temperature sensor 5 could have many other forms and still be considered to be within the scope of this invention, as could control circuit 17.

### Description of Embodiment 200, for Pet Containers in a Vehicle

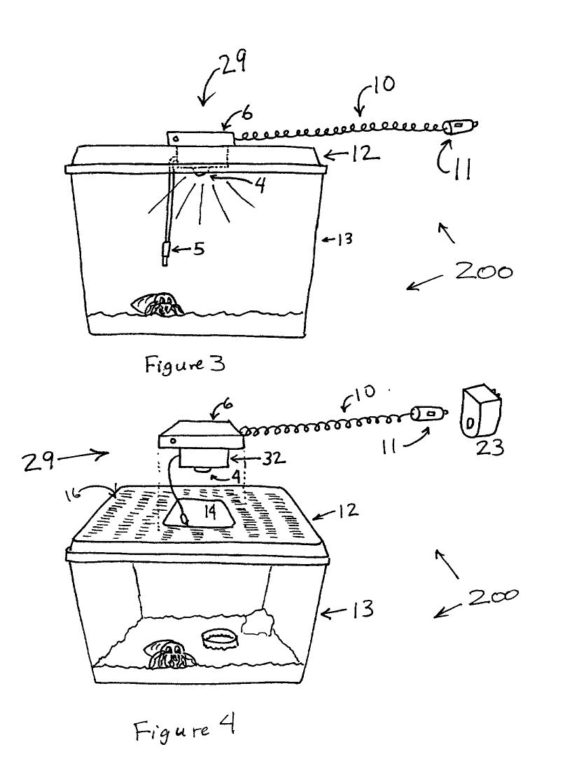

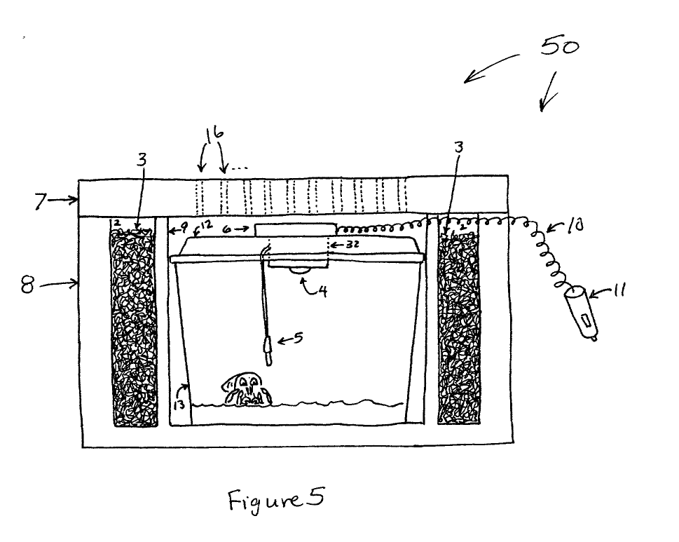

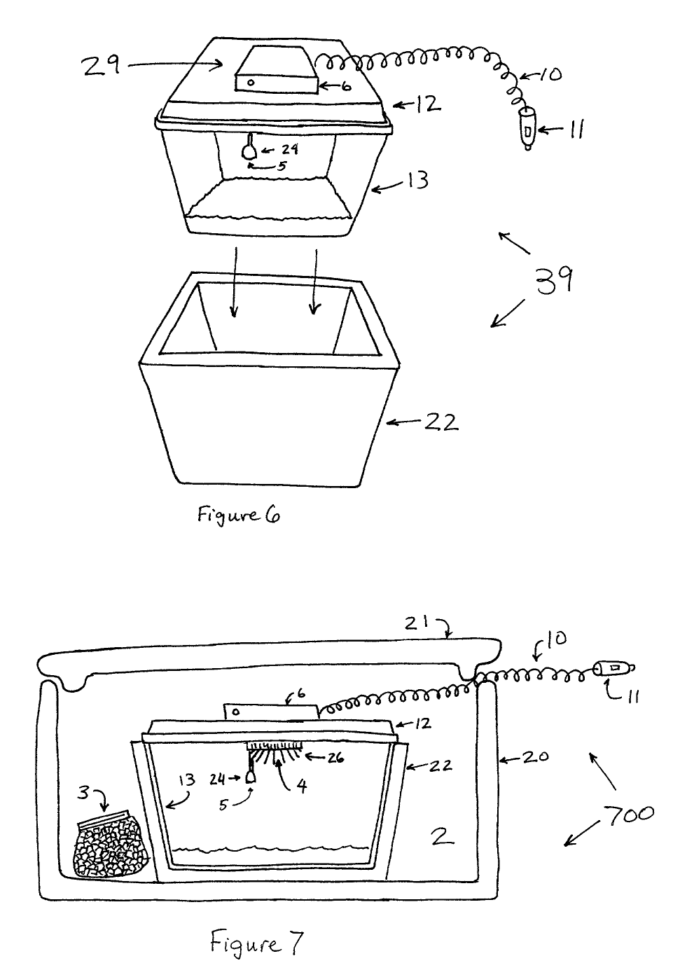

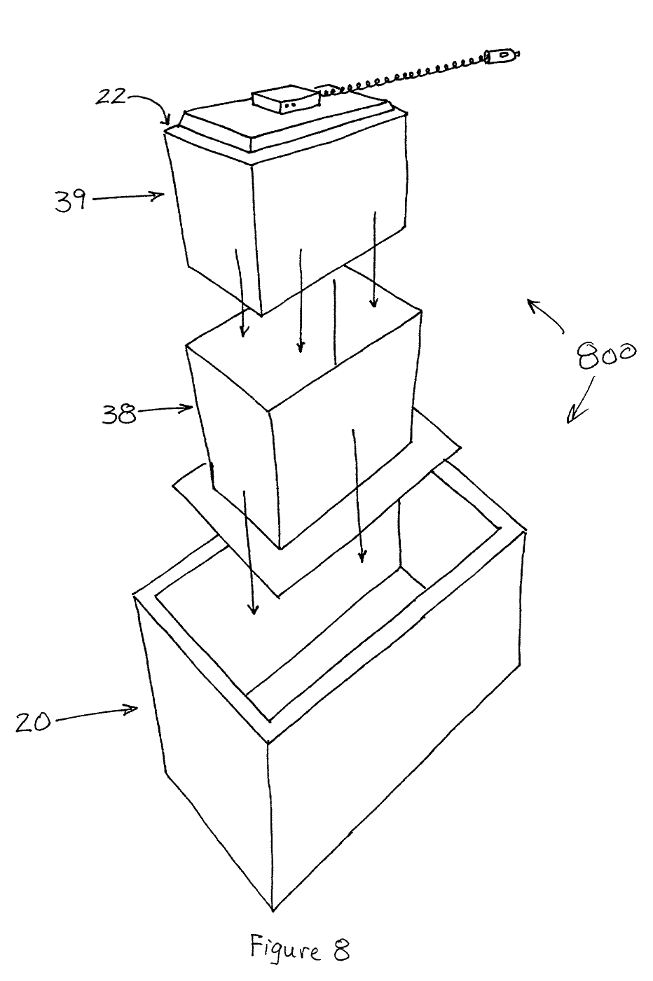

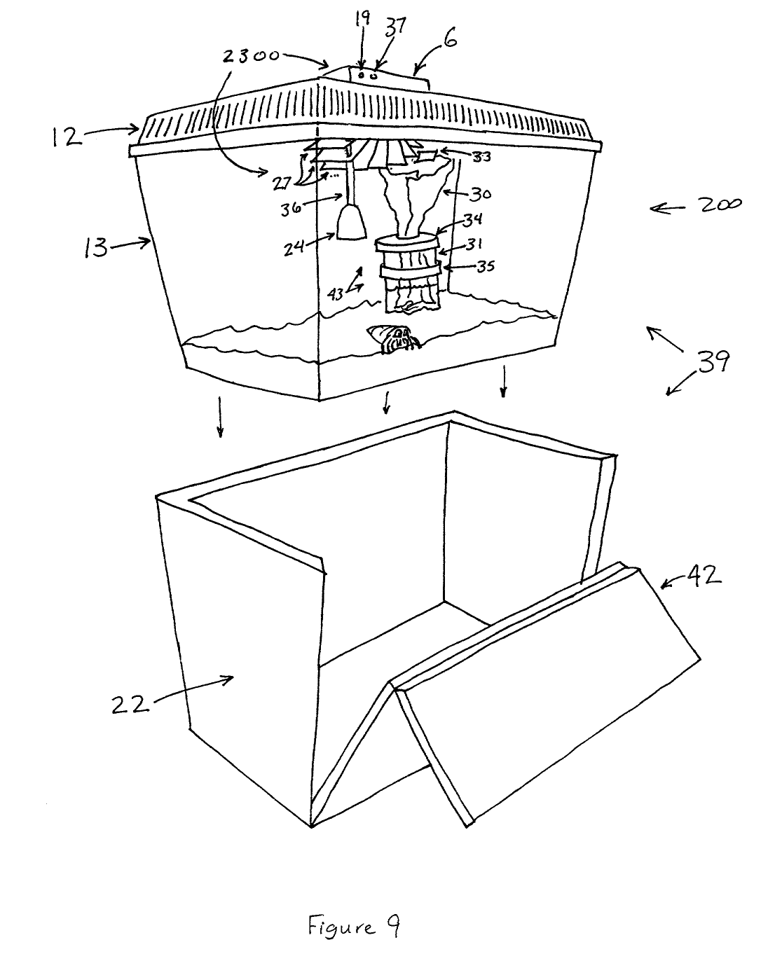

FIGS. 3 and 4 show a typical small pet container 200, fitted with an electronically controlled 12-volt heater unit 29. Housing 6 covers the access hole 14 in the pet container lid 12. Temperature sensor 5 and heating element 4 protrude through the access hole 14 into the interior of the pet container 13. Reflector 15 focuses light and infrared radiation downward from heating element 4 into the pet container 13.

Not shown is that in this embodiment, most of the vent holes 16 in the lid 12 of this commercially available pet container 13 have been closed. Generally, with commercially available pet containers 13 such as the one depicted, the entire lid is effectively a screen. Most animals do not need nearly this much ventilation. Closing the unnecessary ventilation holes 16 greatly reduces the power needed to adequately heat the pet container 13, resulting in a lower-cost heater unit 29.

FIG. 5 is a cross-section, showing an embodiment 50 suitable for traveling with a small pet in an automobile or recreational vehicle. Vent holes 16 allow fresh air to enter the inner chamber 1. This is necessary so the pet can breathe. The size and number of the vent holes merits consideration, because as they allow more air to pass through, the efficiency of the embodiment is reduced.

Another embodiment would be to have the vent holes connect the outer chamber to the outside atmosphere, through the lid 7, or the outer insulating wall 8. This embodiment would need additional vent holes in inner wall 9, providing an indirect air passage from the inner chamber 1, through the outer chamber 2, to the outer atmosphere. This embodiment would have the property of chilling the air before it enters the inner chamber, which may or may not be desirable, depending on a number of factors.

The embodiment shown in FIG. 5 might also have a means for allowing cord 10 to pass from the inner chamber, to the outside of the embodiment, so that plug 11 could be plugged into a power source. Alternatively, cord 10 could serve to prop the lid 7 open slightly as it passes between the lid 7 and the outer insulating wall 8. This configuration could serve as a third embodiment of vent holes 16.

If the embodiment is to be used in a home, cigarette lighter plug 11 would be plugged into transformer 23.

### Operation of Embodiment 200, for Pet Containers in a Vehicle

In FIGS. 3-7 the pet container is placed into inner chamber 1. A cold substance (thermal sink) 3, such as ice is placed in outer chamber 2. Cord 10 is passed between lid 7 and outer insulating wall 8, possibly through a channel designed for this purpose. Plug 11 is then plugged into the cigarette lighter of the vehicle. In this configuration, the proper temperature will be maintained in the pet container, despite the wildly fluctuating temperatures possible in a parked (or moving) automobile or recreational vehicle.

This embodiment contains vent holes 16 to provide fresh air for the animal to breathe. The vent holes 16 may be of a variety of configurations, as discussed in the previous section. The insulating walls (7,8,9) could either be stiff or flexible.

In addition to use in a vehicle, this embodiment of the invention may be used in a home, by plugging plug 11 into transformer 23. If it will not be excessively warm in the environment, no cold substance (thermal sink) 3 is necessary. If it will not be excessively warm or cold in the environment, the enclosure formed by outer insulating wall 8 and lid 7 may not be needed. In fact, this would be a common use for this embodiment, in the home, with just the pet container 13 and the heater unit 29, plugged into transformer 23. Thus, this embodiment could replace other products designed for heating a pet container in the home. This embodiment provides the additional functionality of allowing you to take your pet with you on a road trip, and be able to maintain the proper temperature for your pet's comfort.

FIGS. 6 and 7 show a very inexpensive embodiment of this invention, which assumes that customers will provide their own ice chest 20. Pet container 13 slips into pet container insulator 22. Then, this assembly is placed in an ice chest 20 along with cold substance (thermal sink) 3. Cord 10 passes between ice chest 20 and ice chest lid 21, keeping it slightly ajar, creating an embodiment of vent hole 16.

A variation on this embodiment would also include an insulated lid (not shown) which would be placed on top of the pet container 13 after slipping it into a pet container insulator 22, before placing it into ice chest 20.

### Operation of Preferred Embodiment 700, a Low-Cost Alternative for Pet Containers in an Automobile

The operation of preferred embodiment 700, shown in FIGS. 6 and 7 is nearly identical to that of embodiments 100 and 50, depicted in FIGS. 1 and 5, respectively. The user slips the pet container 13 into pet container insulator 22 and places the assembly into an ice chest 20, which they provide. They then place a container of a cold substance (thermal sink) 3 into the ice chest 20. Examples of the cold substance (thermal sink) 3 include a bag of ice, a cold pack you put in the freezer, or a chemically-activated cold pack. Generally, much less ice is placed into the ice chest 20 than you would use for preserving food items. It is only necessary that the temperature in the ice chest 20 is lower than the desired temperature in the pet container. If more ice than necessary is placed in the ice chest 20, the heater unit 29 will work harder than necessary, possibly resulting in a dead vehicle battery if the embodiment is left in a vehicle for a long period of time.

Once the pet container 13 and insulator 22 are placed in the ice chest 20 with the cold substance (thermal sink) 3, plug 11 is plugged into the vehicle's cigarette lighter. Lid 21 is placed on the ice chest 20. Cord 10 prevents lid 21 from seating on ice chest 20, providing an embodiment of vent holes 16.

### Description and Operation of the Ice Chest Liner

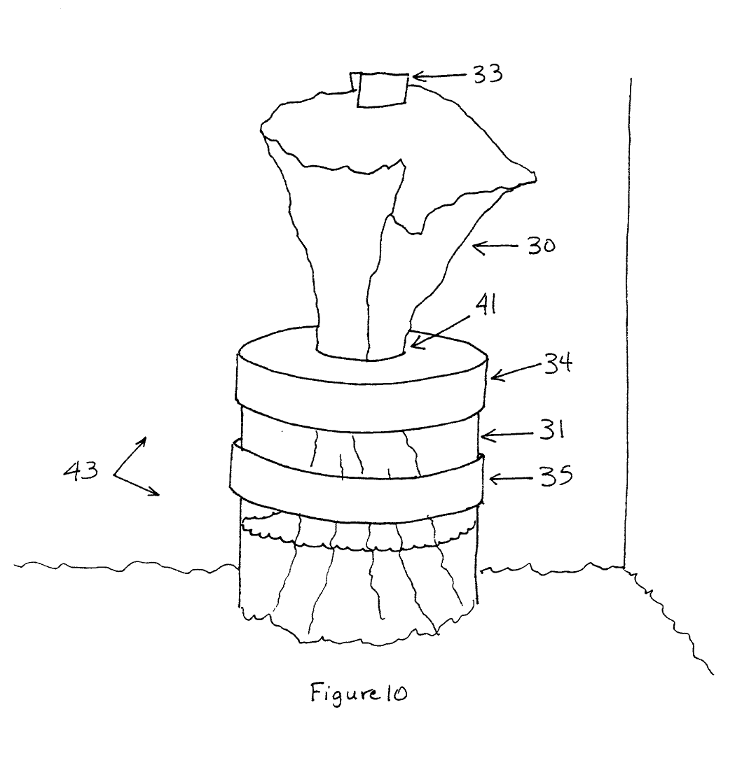

FIG. 8 depicts an embodiment 800 having an ice chest liner 38, which may be used with certain embodiments of outer (cold) chamber 2. For example, this ice chest liner 38 might be used with an ice chest 20 that would be provided by the customer. Or, it could be an integral part of a product that would be sold which included the outer (cold) chamber 2 (i.e. ice chest 20). The ice chest lid 21 is not shown.

Typically, the ice chest liner 38 would only be used for traveling. The pet container assembly 39 would be removed from the ice chest liner 38 upon arrival at a destination. This would make it possible to fold down the front of pet container insulator 22 for viewing of the pet.

One function of ice chest liner 38 is to ensure that there is air space on all sides of the pet container assembly 39. This prevents heat from being transmitted directly through the walls of ice chest 20 into pet container assembly 39. Another function of the ice chest liner is to keep water out of the pet container assembly 39. There is an opportunity for water to enter said assembly if the invention is used for cooling, and ice in the outer (cold) chamber 2 were to melt. If water were to enter the pet container insulator 22, it would be messy when the pet container assembly 39 was removed upon arrival at a destination. Additionally, cold water entering the pet container insulator 22 might place an additional burden on the heater unit 29.

### Description and Operation of the Pet Container Insulator

See FIG. 9. In this embodiment 39, the pet container insulator 22 (a.k.a.insulated inner wall 9), has a front wall 42 that hinges down flat. This enables the pet container 13 to be insulated on three sides, but open on the front during the day, for observation of the pet. Additionally, the front wall 42 of pet container insulator 22 hinges in the middle, allowing the pet container 13 to be insulated on 3½ sides, allowing observation of the pet, but providing more insulation than if the entire front wall 42 were hinged down flat. Generally, the front wall 42 of the pet container insulator 22 would be closed at night or during cold conditions. This not only allows the heater unit 29 to heat the pet container 13 more efficiently, but it makes the pet more comfortable. It tends to get cold near the glass or plastic walls of the pet container 13, unless it is placed inside the pet container insulator 22.

### Description and Operation of the Humidifier

See FIGS. 9 and 10. To provide total climate-control, this invention provides a means for humidity control. The humidity control mechanism 43 consists of a water container 31, a water container lid 34 with wicking element hole 41, a water container attachment 35, a wicking element 30, and a wick attachment 33.

One end of the wicking element 30 is submerged in the water in water container 31. The other end of the wicking element 30 is held up near the roof of the pet container 13 by wick attachment 33. In the embodiment currently in use, the wick attachment 33 is simply a clip attached to a suction cup which is, in turn, attached to the wall of the pet container 13. In the embodiment currently in use, the wicking element 30 is simply a paper towel. A paper towel was chosen for the wicking element 30 because of low-cost and high availability.

The water container lid 34 has a hole 41 about an inch in diameter to allow the wicking element 30 to pass through. The size of this hole 41 may vary, depending upon application. Other sizes of holes 41 should still be considered to be within the scope of this invention. The water container lid 34 serves to purposes: The first is to prevent water from spilling as pet container assembly 39 is jostled about. The second is to help prevent the pet from falling into the water container 31 and drowning. This may or may not be an issue, depending upon the type of pet.

The water container attachment 35 prevents the water container from falling over and spilling. It allows the water container to easily be removed for cleaning. The water container attachment 35 is attached to the inside wall of the pet container 13 such that it can be relocated if desired.

There are several ways to vary the amount of humidity produced by this invention. The humidity can be increased by increasing the surface area of the wicking element 30 which is exposed to the air inside the pet container 13. In the current embodiment, this can be accomplished by fanning out the paper towel. The humidity can also be increased by moving the wicking element 30 closer to heating element 4. The humidity can also be increased by reducing the surface area of vent holes 16. However, caution must be exercised in this approach to ensure that the pet receives enough fresh air through vent holes 16 to breathe. Humidity can be decreased by taking the opposite approach to the steps enumerated above, i.e. reducing the size of the wicking element 30, moving the humidifier farther away from the heating element 4, or increasing the area of vent holes 16.

This humidifier has proven to be inexpensive, reliable, and easy to operate.

### Description and Operation of Other Possible Embodiments

In addition to having the thermal sink in a chamber surrounding the inner (warm) chamber 1, other physical configurations should be considered to be within the scope of this invention. For example, an embodiment should function similarly if the thermal sink were placed inside the warm chamber 1. However, experimentation would be necessary to determine whether or not, and to what extent this thermal sink should be insulated. This would depend on a number of factors such as:

the amount of temperature reduction desired, relative to the outside temperature;

whether or not condensation on the surface of the thermal sink (or melting of the thermal sink) would be a problem;

Whether or not, and to what degree the chamber is insulated.

Another possible embodiment would be to have the thermal sink attached to the outside of the chamber, on one or more sides.

Those familiar with the art can see that it would also be possible to regulate the thermal sink rather than the thermal source. Such a configuration should be considered to be within the scope of this invention.

### Description of Embodiment 29 of the Heater

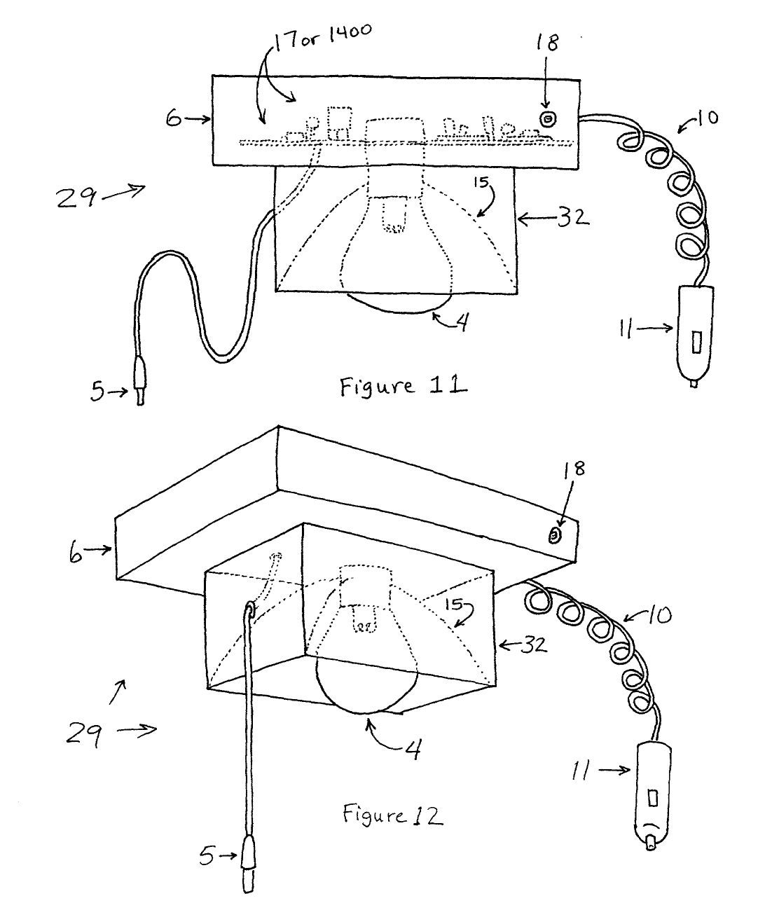

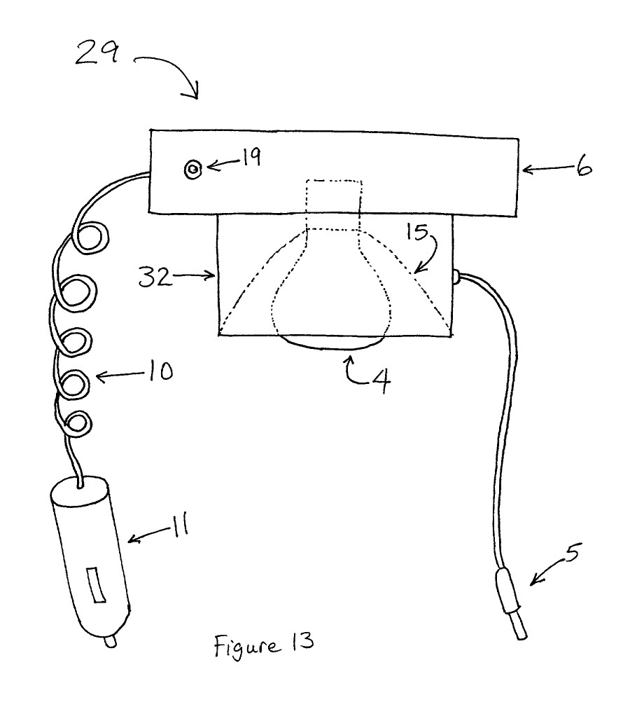

FIG. 11 is a rear view of electronically controlled heater unit 29. FIG. 12 is a perspective view from underneath said heater 29. FIG. 13 is a front view of said heater 29. Plug 11 is attached to cord 10, which, in turn is attached to control circuit 1400 and heating element 4. Heating element 4 is a light bulb in this embodiment. Reflector 15 directs light and infrared radiation downward from heating element 4. Temperature sensor 5 passes through holes in housings 6 and 32 to connect with control circuit 1400. Temperature adjustment screw 18 is accessed through a hole in the rear of housing 6. Indicator light 19 is mounted in a hole in the front of housing 6, opposite temperature adjusting screw 18.

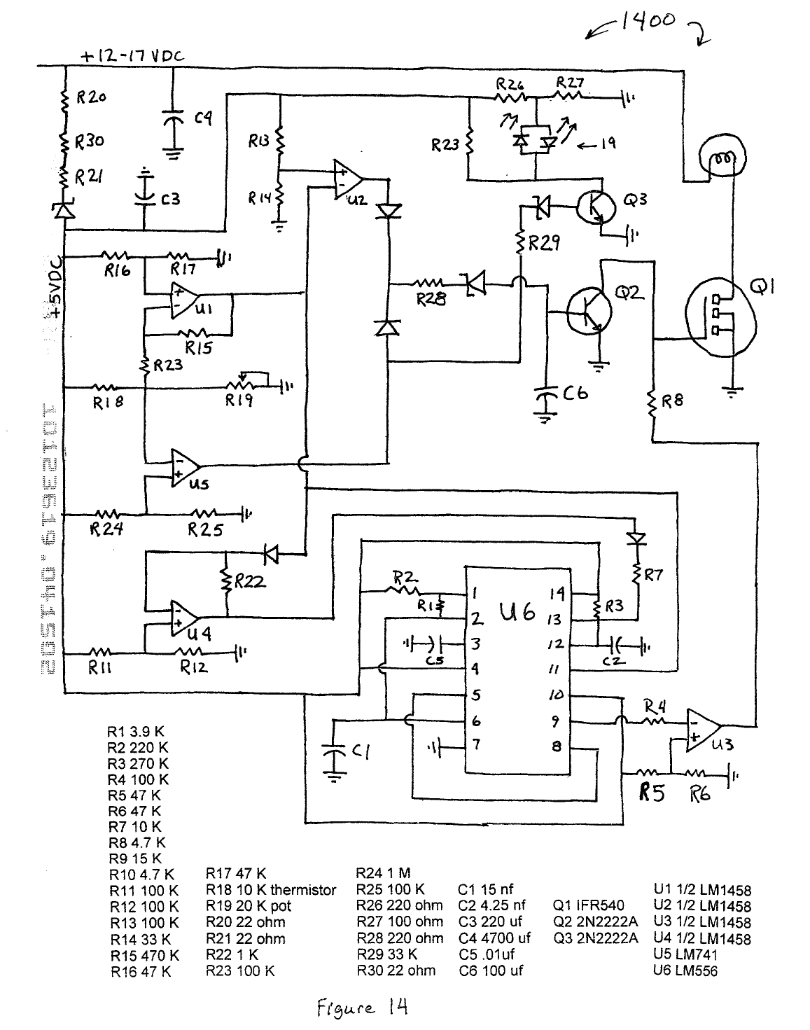

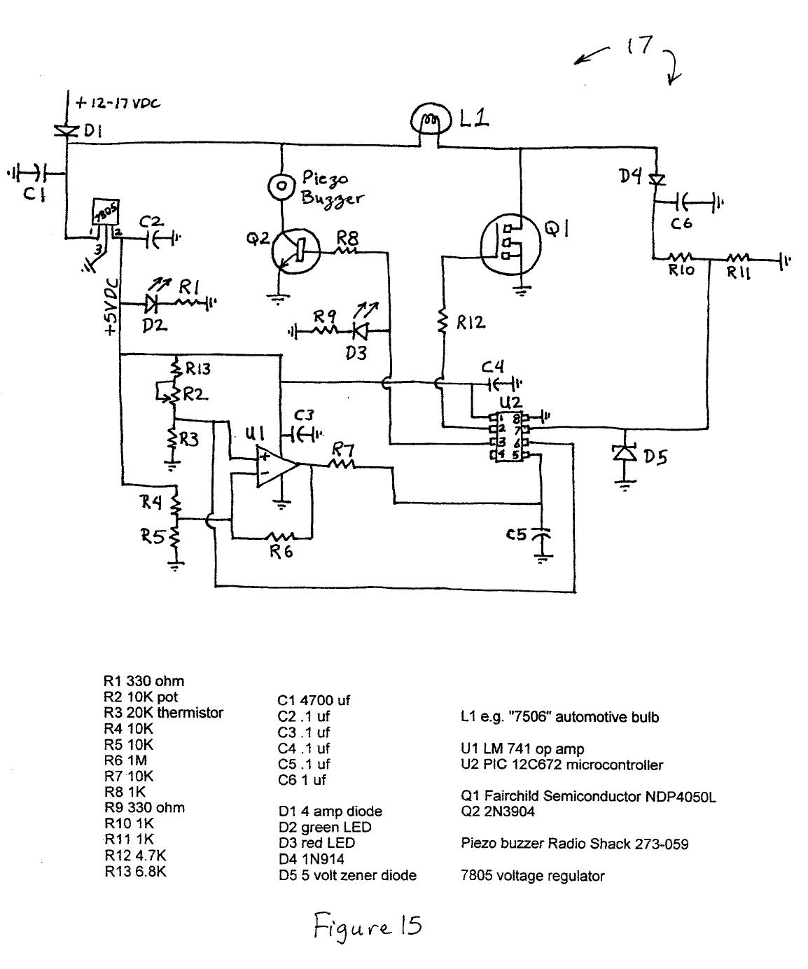

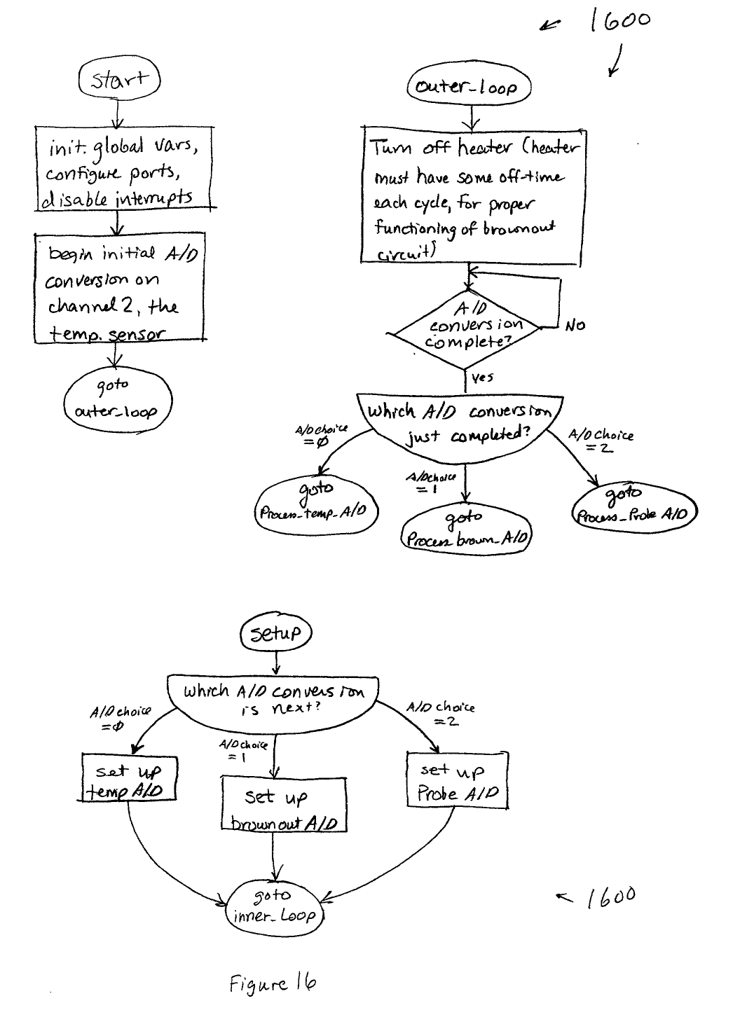

FIG. 14 is a schematic diagram of control circuit 1400. It has five op amps, a 556 timer, a power MOSFET (Q1), a thermistor (R18), which senses the temperature in the pet container 13, a potentiometer (R19), which serves as a temperature adjustment, numerous resistors and capacitors, and an LED which indicates proper functioning of the heater unit 29.

### Operation of Embodiment 29 of the Heater

Proportional Heater Control

The scope of this invention includes any type of control device which regulates heat within an enclosure, including electrical or mechanical thermostats.

Embodiment 29 uses a proportional heater control. This type of control has certain distinct advantages over a typical thermostat, for this application. Whereas thermostats generally cycle the heater from full off to full on and back, this control circuit works more like the cruise-control on your car. If the temperature in the inner chamber becomes slightly lower than the desired temperature, the control circuit administers a small amount of heat. If the temperature continues to drop, the control circuit rapidly begins administering more heat. So for example, if the control circuit was set to engage at 75 degrees Fahrenheit, no heat will be applied if the temperature is above 75 degrees. The amount of heat applied will vary approximately linearly if the temperature is between 74 and 75 degrees. The heat will be on at maximum intensity if the temperature is below 74 degrees.

There is an important advantage to using a proportional heater control in the control circuit. If a powerful heater is employed with a traditional thermostat, the temperature will increase rapidly in the inner chamber, every time heat comes on. This might be uncomfortable for a creature inside. In contrast, this strategy will administer only the amount of heat required, and do so gently and continuously. Thus, a powerful heater may be employed without creating a temperature shock for a creature inside the inner chamber. Unless a lot of heat is required, the device will run steadily and consistently at a small percentage of its capacity. Thus, you have a gentle function to the heater, without sacrificing the large amount of heating power which may be necessary in an extreme environment like a parked automobile or recreational vehicle on a cold day.

Another advantage of this embodiment over other pet container heaters is that it is easy to see at a glance that it is working properly. If it is warm in the room, the light emanated by heating element 4 will be dim or off. If it is cool in the room, heating element 4 will be shining more brightly. Thus, any malfunction of the system is highly noticeable, even if no thermometer is employed.

Operation of Embodiment 1400 of Control Circuit

Embodiment 1400 uses switching technology to control the power applied to heating element 4. The heart of the circuit is the 556 timer U6, which generates a pulse of varying width, depending upon the amount of power required. A wider pulse causes more heat to be radiated into pet container 13. A narrower pulse causes less heat to be radiated.

Op amp U1 applies a varying voltage to the control pin (pin 11) of the 556 chip, to signal the amount of heat necessary. A voltage divider is used, which consists of temperature sensor 5 (R18) in series with temperature adjustment screw 18 (R19). U1 compares this voltage to a fixed voltage, to determine the proper control signal to send to the 556 chip.

Op amp U4 increases the current flowing into capacitor C2 when little power is needed, which further narrows the pulse width emanating from the 556 timer. Op amp U4 receives the same signal that op amp U1 sends to the 556 chip.

The output of the 556 chip is input into op amp U3. Op amp U3, in turn, signals the power MOSFET, Q1, to turn off and on rapidly, with the pulse width and frequency coming out of the 556 chip. This arrangement helps create a nice square wave signal, which prevents excess heat dissipation within MOSFET Q1.

The purpose of op amp U2 is to turn off heating element 4, when the power required gets below about 10% of maximum. When this happens, the control cycles between off and 10%, as needed to maintain the desired temperature. Op amp U2 turns off heating element 4 by increasing the current flowing through transistor Q2, which reduces the amplitude of the pulses signaling power MOSFET Q1 to below its minimum “on” voltage.

In this mode, the operation is similar to a traditional thermostat, but because we are only switching 10% of our total power on and off, the effect is still very gentle. Those of sufficient skill in the art should see that a variety of techniques may be used to decrease the power output essentially linearly all the way down to completely off, if it were desirable for a particular application.

This embodiment switches at 500 Hz. Through experimentation, it was determined that 500 Hz does not produce excessive auditory noise in the heating element 4, which is a 12-volt automotive light bulb of type 7506. Many other types of light bulbs will work just fine, provided the current drawn does not exceed the capacity of Q1 and transformer 23. Many other switching frequencies would also work well, and should be considered within the scope of this invention. Also, additional circuitry could be used including an inductor to eliminate the pulses arriving at heating element 4. This would have the advantage of eliminating the audible noise emanated by heating element 4.

Indicator light 19 is a light-emitting diode, which is either green or red, depending upon polarity. In the circuit, it is normally green, indicating that the system has power. This is important, because if the temperature in the enclosure is warmer than the preset temperature, no light will be emanated by heating element 4. Indicator light 19 reassures the user that the system has power and is functioning correctly, even when heating element 4 is not illuminated.

Indicator light 19 also indicates a failure mode, which would occur if temperature sensor 5 was damaged. This could happen, for example, if an animal chewed through one of the wires to temperature sensor 5. In this case, op amp US detects that the voltage at temperature sensor 5 is out of range. The output of op amp US then causes indicator light 19 to turn red. It also causes the system to shut down by increasing the current through transistor Q2. Without this protection, the system would function at maximum power if temperature sensor 5 was damaged. This would have the effect of quickly raising the temperature in pet container 13 to levels that could be dangerous to the creature inside.

Other colors of indicator lights could work similarly and should be considered to be within the scope of this invention.

Capacitor C4 provides a great deal of filtering of the electricity transmitted through cord 10. Additionally, the voltage powering control circuit 1400 is regulated. In this embodiment, it is regulated by a zener diode and three resistors. Alternatively, one may employ a standard three pin regulator. Voltage to heating element 4 is not regulated. These features add robustness to the system by allowing it to be powered by any transformer whose output is between 10 and 18 volts. These features dramatically reduce the cost of transformer 23, since it need not filter or regulate the power it produces. Also, these features make it possible to safely power the device by transformers other than that sold with the embodiment.

Any system for regulating the heat radiated by heating element 4, (including thermostats) should be considered within the scope of this invention.

### Description of Preferred Embodiment of Control Circuit 17

FIG. 15 is a schematic diagram of a preferred embodiment of control circuit which is numbered 17. This preferred embodiment, control circuit 17, uses a microprocessor U2, which is a PIC12C672 by Microchip. The microprocessor U2, programmed in assembly language, makes it possible to greatly simplify the control circuit 17, reducing cost of production, while providing greater functionality. The following features have been added, over and above embodiment 1400, discussed previously:

The temperature control circuit 17 continually tests for a damaged temperature sensor 5, having either a shorted or open condition. If this occurs, the heater unit 2300 performs an alerting function (i.e. beeps and turns on the red warning light 37, a.k.a. LED D4) and shuts off the heating element 4. An alternative embodiment would be to have the heater unit 2300 continue running at the present duty cycle rather than shutting off. That might provide the greatest likelihood that the pet will be okay until the owner arrives.

The heater unit 2300 will perform its alerting function (e.g. beeps and turns on red warning light 37) if the heating element 4 fails, for example, if a light bulb burns out.

The heater unit 2300 will alert the user if the supply voltage drops below a certain threshold. The unit cuts power to the heating element 4 in this case. If, for example, the heater unit 2300 is plugged into a transformer 23 with insufficient capacity for the heating element 4 used, the effect of this mechanism will be that the unit will alert the user and reduce the duty cycle to something somewhat more manageable for the under-powered transformer 23. But the more common use for this mechanism is that the heater unit 2300 will beep for a couple of seconds when power is removed. The large filtering capacitor C1 supplies power to the control circuit 17 for a couple of seconds after the unit is unplugged, providing the power necessary for the beeping. This is extremely helpful, for example, because the user might not be aware that the power in their cigarette lighter goes away when they remove the ignition key (true on some cars). This alerts the user to a potential hazard for their pet—if they need to leave it in a parked car for awhile. This mechanism also alerts the user if the cigarette lighter plug 11 develops an intermittent connection (as can happen easily), or if transformer 23 fails for some reason. It would be possible to have alternate embodiments of the brownout circuit, if it was desirable to use a more powerful heating element 4 with a less powerful transformer 23 (lower-cost). The idea being that more heating power is typically needed in a car than in a house, because of the greater temperature variations in a car. These embodiments provide various means of reducing the duty cycle of the heating element 4 to within the capacity of transformer 23, by sensing the voltage applied to the heater unit 2300.

### Operation of Said Preferred Embodiment of Control Circuit 17

Operation of the Hardware

See FIGS. a 15 and 23. This preferred embodiment of control circuit 17 works similarly to embodiment 1 in several ways: Both circuits receive power through cord 10 which is, in turn, connected to cigarette lighter plug 11. Cigarette lighter plug 11 is, in turn plugged into either a vehicle cigarette lighter female receptacle, or a female cigarette lighter receptacle attached to transformer 23. Both embodiments use the 12 to 17 volt DC electricity provided by plug 11 and cord 10 to power the heating element 4 (lamp L1). Lamp L1 is a typical automotive light bulb, such as a 7506, drawing about 1.7 amps. In this preferred embodiment, lamp L1 is red in color.

A 7805 voltage regulator is used to provide five-volt DC power to the balance of the control circuit. Capacitor C1 provides filtering and stores power so that the unit can perform its alerting function after cigarette lighter plug 11 has been unplugged. Diode D1 conserves the power in capacitor C1 by preventing it from flowing backward through cord 10 and plug 11, and powering other devices on the vehicle's accessory circuit. Those skilled in the art can see that if a bridge rectifier were substituted for diode D1 the unit could be powered by either AC or DC electricity. This might be of value, as AC transformers are less expensive than those which produce to DC. Such an embodiment (use of a bridge rectifier and an AC transformer) should be considered within the scope of this invention, as should the embodiment presented, which would use a DC transformer.

U1 is an LM741 Op amp. It takes as input, a signal from the temperature sensor resistor network (R2, R3, and R13), and it outputs a signal to the microprocessor, indicating how strongly the heating element 4 should operate. The operation of this portion of the circuit is similar to that in embodiment 1. A connection is made between the temperature sensor resistor network (R2, R3, and R13) and the microprocessor U2 itself. This connection provides the microprocessor U2 with a signal it can use to perform a sanity check, to detect damage to the temperature sensor 5 (R2).

Diode D2 is green in color in this embodiment and indicates that the unit has power. Diode D3 is red in color and is used to indicate an error condition in the operation of heater unit 2300. In addition, a piezo buzzer is used to make an alerting sound in the event of a problem. The piezo buzzer is powered by the 12-volt portion of the circuit, in order to make it louder. It is switched on by transistor Q2 if microprocessor U2 detects an error condition.

Lamp L1 (a.k.a. heating element 4) is switched on and off by transistor Q1, which is a Fairchild Semiconductor NDP4050L power MOSFET. Microprocessor U2 switches transistor Q1 on and off at a frequency that varies between approximately 400 and 800 Hz. The duty cycle varies nonlinearly in response to output of Op amp U1. This mechanism is discussed in greater detail in the section entitled “Pulse-Width Modulation with a Variable Period.”

The final portion of the circuit serves to detect various error conditions relating to the input voltage to the entire control circuit 17. Errors detected include failure of the heating element 4 (e.g. a burned-out light bulb) and low system voltage (e.g. if the heater unit 2300 has been powered off and is running on the power remaining in capacitor C1). The point in the circuit between lamp L1 and transistor Q1 is connected to a circuit comprising diode D4, capacitor C6, resistors R10, and R11, and zener diode D6. This circuit provides a model of the system voltage to the microprocessor U2. The microprocessor U2 uses this reference voltage to determine if a failure has occurred, whereupon it will perform its alerting action. This mechanism is discussed in more detail in the subsequent section entitled “Brown-out Detection Circuit.”

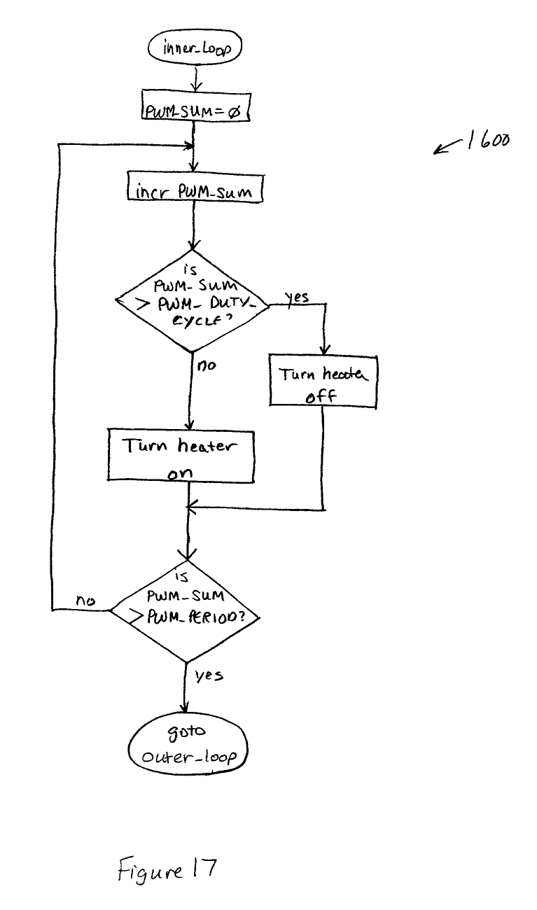

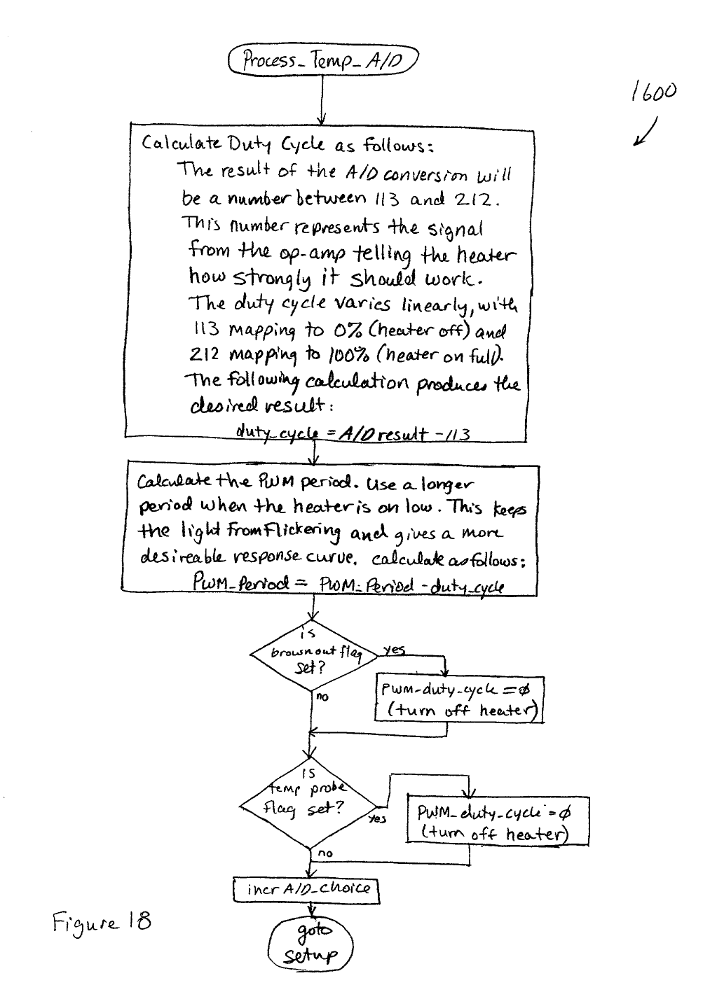

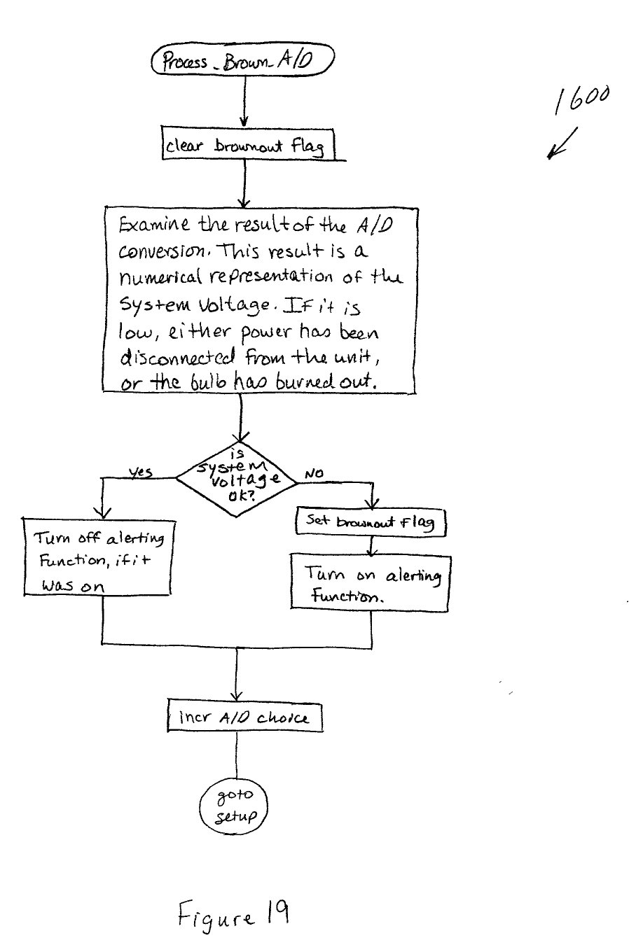

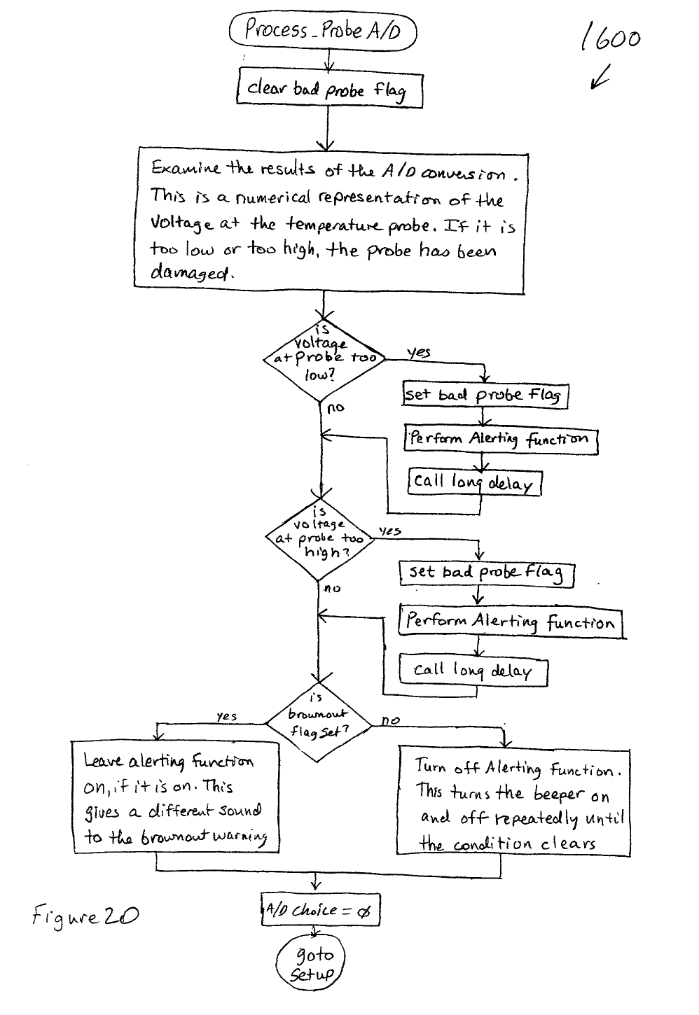

Operation of the Firmware/Software 1600, FIGS. 16-20

The basic algorithm used in firmware/software 1600 is very simple. It is most easily described by first presenting a simplified embodiment. In this simplified, exemplary embodiment, microprocessor U2 is constantly monitoring the voltage applied to pin 5. This voltage is the signal from op amp U1, indicating how strongly the heater should work. Microprocessor U2 calculates a duty cycle which increases along with the voltage applied to pin 5. Once this duty cycle has been calculated, the firmware enters a loop. This loop is executed approximately 100 times, with the lamp L1 (a.k.a. heating element 4) on at first, and then switching to off after the correct number of iterations. So for example, if the duty cycle was supposed to be 45%, this inner loop would iterate 45 times with the lamp L1 turned on, followed by 55 iterations with the lamp L1 turned off. At the end of the 100 iterations of the inner loop, the firmware would execute the outer loop again, which includes testing of the voltage applied to pin 5, to determine the new duty cycle. This process repeats over and over. In this way, a simple algorithm is used which takes advantage of the A/D converters on the PIC12C672 (U2) to provide pulse-width modulation to vary the power applied to heating element 4.

The preferred embodiment of firmware/software 1600 is somewhat more complex. For a couple of reasons, the pulse-width modulation period is varied as described in a subsequent section entitled “Pulse Width Modulation with a Variable Period.” Additionally, the preferred embodiment checks for the following error conditions: system voltage too low, failure of lamp L1, and a damaged temperature sensor.

See FIGS. 16 through 20. Similarly to the simplified embodiment described above, the firmware has an outer loop and an inner loop. The outer loop executes exactly one time for each PWM period. The inner loop executes between approximately 100 and 200 times for each execution of the outer loop. The inner loop iterations start with lamp L1 in the on-state. After a number of iterations in the on state, lamp L1 is switched off, and remains off for the remaining iterations of the inner loop. The duty cycle determines the number of iterations of the inner loop for which lamp L1 is in the on-state.

The outer loop consists of two parts. First the outer loop processes the results of various A/D conversions. Second, the outer loop executes the inner loop (described above), which turns lamp L1 on and then off for precisely one PWM period. There are three different A/D conversions to be processed in the first part of the outer loop. The outer loop processes A/D conversions to check the desired duty cycle for lamp L1, to check the system voltage (brownout), and to check that the voltage at the temperature probe is within range. The outer loop checks these in a round-robin fashion. In other words, the outer loop will first process the duty-cycle A/D conversion, whereupon it will execute the inner loop, to turn lamp L1 on and then off for one PWM period. On the next iteration, the outer loop will first process the brownout A/D conversion to check system voltage, and then execute the inner loop, turning lamp L1 on and then off for yet another PWM period. On the third iteration of the outer loop, it will first process the probe-OK A/D conversion which checks to see if the voltage at the temperature probe is within range. Then it will, once again, execute the inner loop, turning lamp L1 on and then off for another PWM period. On the fourth iteration of the outer loop, the cycle starts over, with the outer loop once again processing the duty-cycle A/D conversion. Thus, every third PWM period, the desired duty cycle is checked; every third PWM period, the system voltage (brownout) is checked; and every third PWM period, the voltage at the temperature probe is checked for sanity. The firmware continues on, indefinitely, in this fashion.

If the results of the error-checking A/D conversions described above indicate a problem, the alerting function is performed, and the duty cycle is set to zero, effectively turning off lamp L1 (a.k.a. heating element 4). The alerting function is performed by writing a “1” to pin 3 of microprocessor U1, which turns on the piezo buzzer and diode D3 (a.k.a. red warning light 37).

In this section, the basic operation of the firmware was described, at a high level. The following sections describe in detail certain novel aspects of the firmware, which help make the unit more robust in its operation.

Brown-Out Detection Circuit

A product based on this invention should be as reliable as possible. This focus on reliability must take into consideration the fact that the heater unit 2300 is part of a larger system which delivers it power. There are numerous potential problems with the larger system that provides power for this unit. Cigarette lighter plugs in automobiles are not particularly reliable. The connection can easily work its way loose due to vibration, or people may not realize that on their particular car, the cigarette lighter loses power when the key is turned off. There are other problems which could arise when the heater unit 2300 is powered by a 12-volt transformer 23 connected to commercial power. There can be power failures, or transformer 23 itself, could fail. Given that most people are relatively attached to their pets, a number of features have been added to this invention to reduce the likelihood that any of the above-mentioned failures could harm their pet. Additionally, one embodiment which will be described shortly, has a feature which makes it possible to lower the cost of transformer 23, as less power will generally be needed in a home than is needed in a car. Yet another function of this mechanism is to detect a failure of the heating element 4, for example, a burned-out light bulb.

Brownout Mechanism—Basic Operation

All of the above scenarios can be detected by testing the voltage at the point in the circuit 17 between lamp L1 (a.k.a. heating element 4), and the transistor Q1 which provides its connection to ground. (See FIG. 15.) This test must be done when the transistor Q1 is in the “off” state. As a result, the duty cycle of the heating element 4 must be limited to slightly less than 100%. When the transistor Q1 is in the “off” state, the voltage at the input to the entire device can be seen through the heating element 4. This voltage causes current to flow through diode D4 to charge capacitor C6. The purpose of capacitor C6 is to store this reference voltage during the times that transistor Q1 is in the on-state. This provides a relatively steady voltage which approximates the voltage input to the entire system. This relatively steady voltage is necessary to allow the A/D converter in the microprocessor U2 to function correctly. Resistors R10 and R11 provide a voltage divider which, in combination with the five-volt zener diode, ensure that the reference voltage provided to the microprocessor U2 will not exceed the operational limits of the microprocessor U2.

See FIGS. 16 through 19. Now that we have provided the microprocessor U2 with a representation of the input voltage to the heater unit 2300, we can use firmware to provide the features described above, as follows: The microprocessor U2 checks this voltage once every PWM period—approximately 100 to 200 times per second. The microprocessor U2 will shut off the heating element 4, and will perform its alerting action (e.g. beep and turn on red warning light 37), if the voltage falls below a preset threshold. If the heater unit 2300 is being powered off, the voltage will rapidly fall below the threshold, at which point, the heating element 4 will shut off and the heater unit 2300 will perform its alerting function. The large filtering capacitor C1 will provide enough power for the unit to alert for several seconds. If the heating element 4 (e.g. light bulb) has failed, this reference voltage will instantly drop to zero, even though the unit is still receiving power. The same action is appropriate, however. The heater unit 2300 will perform its alerting function continuously until the condition is rectified (e.g. light bulb is replaced).

There is a third function this mechanism provides, which is to protect, to a limited degree, transformer 23 in the event that the heater unit 2300 is drawing excessive current. This could happen, for example, if a person traveling with their pet were to replace the heating element 4 with a light bulb of higher wattage. In this case, assuming the heater unit 2300 was needing to run at full capacity, (e.g. in order to restore the pet container 13 to its preset temperature) the reference voltage would drop rapidly due to the excessive current drawn by the new heating element 4. When the reference voltage drops below the threshold, the heater unit 2300 will perform its alerting function and shut off the heating element 4. At this point, the unit will no longer be drawing excessive current, and the reference voltage will rise, once again, to a point above the threshold. Seeing that the reference voltage is now above the threshold, the heater unit 2300 will turn off the alerting function and engage the heating element 4, once again. The cycle keeps repeating over and over like this. The result of this cycling on and off of the heating element 4, is to crudely reduce the duty cycle of the heater unit 2300 (and therefore, the current drawn) to something more or less tolerable by transformer 23 and at the same time, make it clear to the user that something is wrong. The beauty of this arrangement is that after the temperature in the pet container 13 reaches the preset temperature, the heater unit 2300 will exit this power-cycling mode, and function normally, assuming that the preset temperature can be maintained with a current draw that is comfortable for transformer 23. As such, the heater unit 2300 makes the best of a bad situation—still able to keep the pet safe, in spite of having the wrong light bulb.

First Alternative Embodiment of the Brownout Mechanism

Another embodiment of this invention is possible, to more fully take advantage of the heater unit 2300's ability to adapt to an insufficiently powerful transformer 23. This embodiment would allow the use of a less-expensive transformer 23, assuming that less heating power is needed in a home than in a car. In this embodiment, if the reference voltage falls beneath the threshold, the firmware will first assume that too great a load is being placed upon transformer 23. As a result, the firmware will begin rapidly reducing the duty cycle of the heating element 4, until the reference voltage returns to a level above this highest threshold. If the duty cycle falls to zero, the heater unit 2300 will assume that there is another problem. This problem would be that either all power has been removed from the heater unit 2300, or that the light bulb has failed. In either case, it is appropriate to alert the user of this situation. In the case that all power has been removed from the heater unit 2300, the large filtering capacitor, C1 will provide enough power for the unit to perform its alerting action (e.g. beep and turn on red warning light 37) for several seconds. In order to take advantage of this mechanism, it would be helpful to use a transformer 23 that can operate indefinitely with a load that draws its output voltage down to about 10 volts or so. The reason for this is that if the heater unit 2300 is in a car which has a failing battery, we do not want the unit to reduce its power consumption and risk harm to the pet. As such, the threshold needs to be set fairly low, for example, about 10 volts. Another advantage of using a slightly lower-voltage transformer 23 is that it would prolong the life of the heating element 4.

Second Alternative Embodiment of the Brownout Mechanism

Another embodiment is possible, of the mechanism for adapting to a less-powerful transformer 23. In this embodiment, the heater unit 2300 would enter a test procedure upon initially being powered up. In this test procedure, the unit would turn on heating element 4, and gradually increase the duty cycle, while monitoring the reference voltage. If the reference voltage drops below a threshold, the firmware would set a “Max-duty-cycle” variable internally, to the duty cycle present at the time the reference voltage crossed the threshold. The firmware would then limit the duty cycle to values less than this “Max-duty-cycle” variable. The functionality described in the “Brownout Mechanism—Basic Operation” subsection above, would be unchanged.

Third Alternative Embodiment of the Brownout Mechanism

A variation is possible on the embodiment described in the previous subsection. This variation would not use an initial test procedure, however. This embodiment would use a “Max-duty-cycle” variable, which would be set to a very low value, upon initial power-up. In this embodiment, when the current duty cycle is equal to the “Max-duty-cycle” variable, the reference voltage would be tested. If the reference voltage is above the threshold, the “Max-duty-cycle” variable would be increased, allowing the duty cycle to be increased, along with it. In this way, as the heater unit 2300 operates, it would discover the maximum duty cycle allowed for the particular transformer 23 and heating element 4 being used. Another advantage of this embodiment is that when the heater unit 2300 powers up, the heating element 4 would power up more gradually, possibly prolonging its life. Another advantage which applies to this embodiment, as well as the one in the previous subsection, is that the “Max-duty-cycle” variable does not decrease. This prevents the heater unit 2300 from “adapting” to a dying car battery by reducing the duty cycle, possibly harming the pet.

The brownout mechanisms described in this section provide the following functionalities: alert the user to a defective heating element 4 (e.g. a burned-out light bulb), alert the user if the heater unit 2300 loses power, and provide protection for transformer 23, in the event that a heating element 4 with higher current draw (e.g. higher-wattage light bulb) is substituted.

The scope of this invention should include any method by which the current drawn by a load is regulated to prevent over-loading of the power supply providing power to this load.

Pulse-Width Modulation with a Variable Period

See FIGS. 16, 17, 18, and 21. The purpose of this feature is partly esthetic and partly functional. The functional aspect of this feature is that it is useful to have a heater control with low gain when little heating power is needed, and high gain when more heating power is needed. This allows for some variation in the temperature inside the pet container 13 when the pet container assembly 39 is being used in an environment such as a house, with relatively mild temperature swings. This variation in temperature is useful because it mimics temperature changes in the animal's natural environment. On the other hand, in an environment such as a car, where temperature changes are more dramatic, having higher gain when more heating power is needed helps make sure that the temperature in the pet container 13 does not fall below a minimum which is comfortable to the pet.

The esthetic problem is that in earlier embodiments of this invention, the light bulb (heating element 4) would tend to flicker when the heater unit 2300 is operating at a very low power level. The reason for this is that due to the use of an 8-bit A/D converter, there are only about a hundred discrete power levels between full-on and full-off. As such, when the heater unit 2300 would make the transition from say, 5% to 6% duty cycle, the result would be a visible increase in the brightness of heating element 4. The unit would have a tendency to make this kind of transition fairly often, causing the light bulb to flicker, giving an appearance of poor quality.

A simple solution to both problems can be implemented in the firmware. The flickering can be eliminated by creating discrete power levels that are closer together when the heater unit 2300 is operating at low power levels. So, for example, the unit has the ability to go from say, 5% to 5.5% duty cycle, rather than having to make the larger jump from 5% to 6%. The question is how to do this, given that only about a hundred discrete power levels are available to choose from. The solution used in this invention is to lengthen the PWM period as the duty cycle decreases. So for example, when the heater unit 2300 is operating at 99% duty cycle, the firmware loop will iterate approximately 100 times, with the heating element 4 in the on-state for the first 99 iterations. When the heater unit 2300 is operating at a 1% duty cycle, the firmware loop will iterate approximately 200 times, with the heating element 4 in the on-state for only the first two iterations. This mechanism is accomplished fairly simply, as illustrated in the following pseudocode:

Max_PWM_period=200;

PWM_period=Max_PWM_period−duty_cycle;

/*PWM period increases as duty cycle decreases*/

for (i=0; i<PWM_period; i++) {

if (i<duty_cycle)

<turn heater on>

else

<turn heater off>

}

It is important to note that the number 200 is arbitrary and an approximation of what is actually used in the current preferred embodiment of the invention. This is a general example of a particular mechanism which would work similarly regardless of the numbers used.

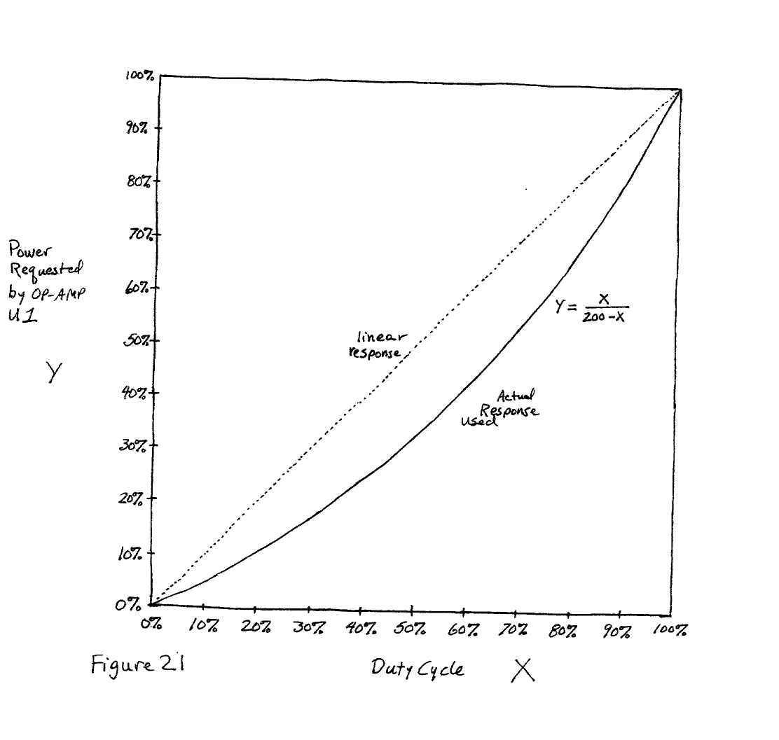

FIG. 21 is a graph which further depicts the operation of this mechanism.

One can see that by adding a couple of lines of code, it is very simple to increase the PWM period when the heater unit 2300 is operating at low power levels. This simple mechanism solves an esthetic problem in which the light would tend to flicker when operating at low power levels. This mechanism also provides heater unit 2300 with a response curve which is more comfortable for the pet.

### Description and Operation of the Heater Grill Embodiments

One issue that has come up in discussions with reptile owners is the need to protect an animal, such as a snake, from contact with anything hot. One must assume that a snake has access to any location in the pet container 13, including the walls and ceiling. Any type of heating element 4 that generates substantial amounts of infrared radiation must have a part of itself that becomes very hot. In the embodiment currently in use, that would be the light bulb. It is necessary to provide a barrier which would effectively prevent an animal from contacting any hot parts of the heating element 4. This barrier must be transparent to infrared radiation. Furthermore, this barrier must be of such a design as to promote good air circulation within and around the heating element 4, in order to prevent excessive heat buildup.

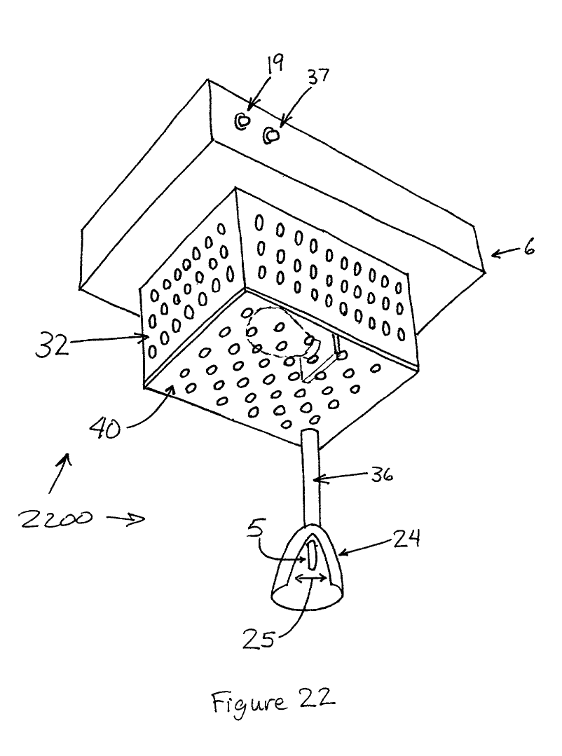

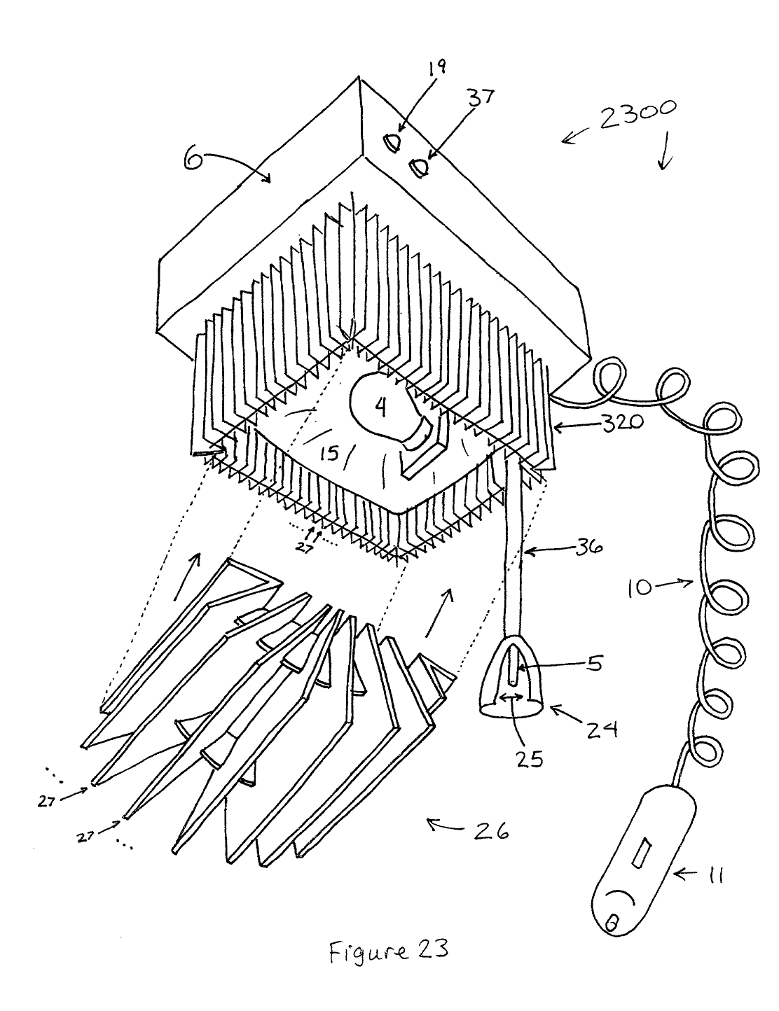

See FIG. 22. In this embodiment of heater unit 2200, simple heater grill 40 is placed in front of the heating element 4. Simple heater grill 40 is select embodiment, a flat sheet of transparent material, such as polycarbonate. It is generally necessary to have holes in this heater grill 40 as well as in the heater element housing 32, to facilitate air circulation and prevent excessive heat buildup. Depending upon the power of the heating element 4, this embodiment might work for certain applications. However, another, preferred embodiment is presented, which remains cool to the touch, even with a fairly powerful heating element 4, of 20 watts or so.

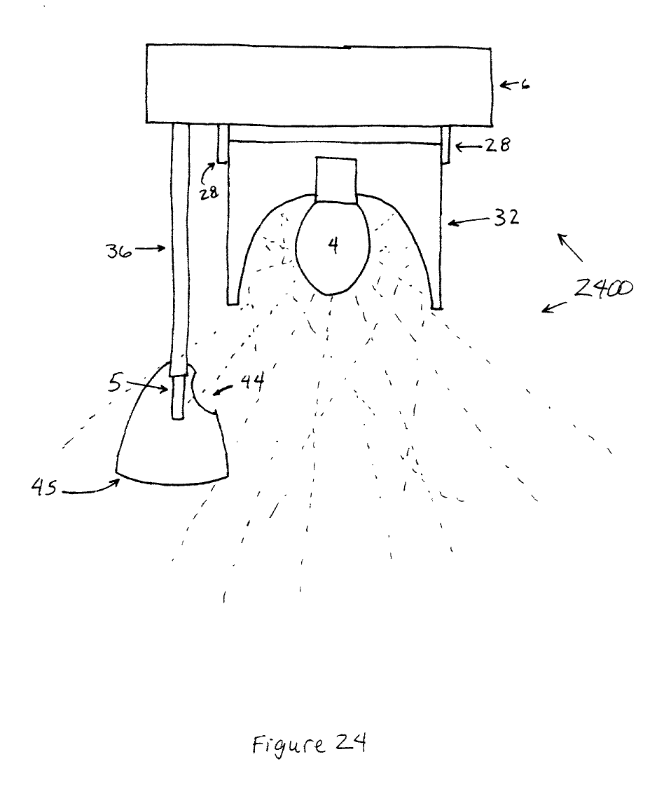

See FIG. 23. In this preferred embodiment 2300, heater grill 26 is constructed with fins 27 radiating outwardly from heating element 4. The fins 27 provide a barrier, and also dissipate the heat they absorb into the air, due to their large surface area. One requirement of this embodiment of a heater grill 26 is that the fins 27 be close enough together that an animal would be unable to reach between them and access any hot parts of the heating element 4. While this distance is going to vary somewhat, depending upon the animal, the current embodiment places the fins 27 3/16″ apart.

The fins 27 would generally be made out of a thermally insulating material, such as plastic. Additionally, the fins 27 should be made out of material which is transparent to infrared radiation. In the current embodiment, transparent polycarbonate was used to make the fins 27. There is another benefit to the use of transparent material for the fins 27, which is partly functional and partly esthetic. The red glow from the heating element 4 is transmitted through the clear plastic, illuminating the edges of the fins 27. Keep in mind that the heating element 4 is tucked out of sight within reflector 15, and cannot ordinarily be seen. The red glow at the edges of fins 27, in addition to being visually appealing, provides the user with a visual indication of the intensity with which heating element 4 is functioning. This provides an additional level of safety for the animal. If the user notices that heating element 4 is functioning more strongly or weakly than usual, or is not functioning at all, the user has an opportunity to take corrective action, hopefully, before any harm comes to the animal. Heaters which do not provide any indication of the intensity of their function are more likely to cause harm to the animal, as a malfunction would less likely be noticed.

Note that in FIG. 23, heater element housing 320 is made similarly to heater grill 26, with fins 27 radiating outwardly from the vicinity of heating element 4. All of the above discussion of heater grill 26 applies equally to heater element housing 320.

The scope of this invention should include any use of fins, flat or otherwise, radiating outwardly from a heat source, to prevent contact with something hot. These fins can be any shape, but should have greater surface area than a wire or rod of comparable thickness. The purpose of said surface area is to dissipate heat. This invention replaces the wire grills that are commonly used to prevent contact with something hot in devices such as heaters. In this invention, the outer edges of the fins remain cool to the touch, even when the inner edges are in fairly close proximity to a heat source. Additionally, the scope of this invention should include colors of light other than red being transmitted to the edges of the fins, for decorative purposes and/or to indicate the intensity of operation of the heater. The transmission of light through the fins is an optional part of this invention. The scope of this invention should include fins of any color, and made out of any material. The scope of this invention is such that it applies to any heater or heat-producing device, not limited to those used in enclosures containing pets. A particularly important use for this invention would be on space heaters, such as those used in a home, particularly a home containing children or pets. This invention could prevent injury in the event that a person comes in contact with the heater grill. The grill gets hot on many space heaters not equipped with this invention.

### Description and Operation of Temperature Sensor Reflector

See FIGS. 22, 23, and 24. One challenging aspect of this invention deals with how to accurately measure the temperature down where the animal is. This is more of a challenge in a tall pet container than in a short one. One approach used in earlier embodiments was to physically lower the temperature sensor 5, so that it was measuring the air temperature about an inch above the floor of the pet container 13. There are a couple of problems with this approach. One is that the animal may attempt to climb up the temperature sensor 5 in order to escape from the pet container 13. Another is that depending on the pet container 13 that the heater unit 2300 is used in, the distance from the unit to the pet container 13 floor is not known. These factors make it desirable to have a temperature sensor 5 that measures the temperature on the pet container 13 floor, without actually being on the pet container 13 floor.

A solution is to place a temperature sensor reflector 45 around the temperature sensor 5. In the embodiments presented in FIGS. 22 through 24, the temperature reflector 45 (and 24) and the temperature sensor 5 are held stationary by temperature sensor tube 36. Note that a second purpose of sensor tube 36 is to make it impossible to lay the unit flat on a surface, reducing the risk that heating element 4 could cause a fire. A third purpose of temperature sensor tube 36 is to ensure that the lid 12 cannot be closed with the sensor 5 outside of the cage. This could easily and accidentally happen if the temperature sensor 5 was simply suspended by a wire.

The purpose of temperature sensor reflector 45 is to focus infrared radiation from the pet container 13 floor onto the temperature sensor 5. This helps the device to more accurately regulate the temperature on the pet container 13 floor, where it needs to be regulated. There is one problem with this approach, however. The temperature sensor reflector 45 serves to effectively shade the temperature sensor 5 from the infrared radiation emanating from the heating element 4. Under some circumstances, this causes the heating element 4 to cycle from full-on to full-off, creating a temperature change of about 4 degrees Fahrenheit with each cycle. Cycling apparently occurs when the infrared radiation from heating element 4 is absorbed by the interior of the pet container 13 such that there is a delay between the absorption of said heat and the actual rise in the temperature of the pet container 13. Thus, heat absorbed by the interior of the pet container 13 continues to warm the air in the pet container 13 for a period of time after the desired temperature has been achieved. This cycling may be eliminated by providing the heater unit 2300 some feedback which has a faster response time than the actual heating of the pet container 13 interior. This was accomplished in this invention by putting an infrared feedback hole 44 in the temperature sensor reflector 45, which allows some infrared radiation from the heating element 4 to actually strike the temperature sensor 5. By varying the size of the hole 44, one can adjust the amount of infrared radiation which strikes the temperature sensor 5, effectively adjusting the sensitivity of the unit. An alternate embodiment of this invention might use a wedge-shaped feedback hole 44, so that by rotating the temperature sensor reflector 45, one could increase or decrease the amount of infrared radiation striking the temperature sensor 5, providing a quick adjustment for the sensitivity of the unit. Yet another embodiment 24 of this invention would be to cut away approximately 25% of the temperature sensor reflector, leaving a large cutaway window 25 facing the heating element 4. Cutaway window 25 could also have a wedge-shaped embodiment, for the reasons stated above. Embodiment 24 has the added advantage that it eliminates most of the rather large shadow cast by the temperature sensor reflector in the other embodiments.

In some applications, a temperature sensor reflector 24 (or 45) is not needed.

Although the present invention has been described with reference to preferred embodiments, numerous modifications and variations can be made and still the result will come within the scope of the invention. No limitation with respect to the specific embodiments disclosed herein is intended or should be inferred.

I claim:

1. A pet enclosure comprising:
a pet container having walls and a bottom;
an ice chest sized to receive the pet container and hold a cold substance;
a heater for the container; and
a temperature controller for the heater.

2. The apparatus of claim 1, wherein the pet container further comprises an insulated shell.

3. The apparatus of claim 1, wherein the cold substance further comprises ice.

4. The apparatus of claim 1, wherein the heater further comprises an electrically powered heating element.

5. The apparatus of claim 4, wherein the temperature controller further comprises a control circuit mounted to a top of the pet container and having a temperature sensor depending from the control circuit into the pet container.

6. The apparatus of claim 4, wherein the heater further comprises a cigarette lighter male plug.

7. The apparatus of claim 6, further comprising a house-current to low-voltage power converter having a cigarette lighter female plug.

8. The apparatus of claim 5, wherein the top further comprises a hole sized to accept a heater element housing and a temperature sensor.

9. A portable container comprising:
an insulated outer wall;
an interior storage space defined by a closed loop insulated wall;
a top for the container;
said top having an electrically powered heater with a temperature controller for controlling a temperature in the interior storage space; and a coolant between the insulated outer wall and the closed loop insulated wall, thereby providing a temperature controlled environment in the interior storage space for both hot and cold ambient temperatures.

10. A heater for a portable container,
said heater comprising:
a sensor;
a heating element;
a DC power source;
a power connection for the power source;
a house-current to low-voltage power converter;
a control circuit having circuitry to control the temperature in the container, sense a sensor out, a heating element out, a power connection out; and
an audible alarm to alert a user of any outage.

11. A heater grill comprising:
a heater element in a housing;
said housing having fins with a first space between at least one pair of fins opening directly to the heater element;
a grill attachable to the housing;
said grill having at least a pair of fins with a second space there between opening directly to the heater element; and
wherein said first and said second space are each sized to restrict an entry of a human or pet animal.

12. A temperature probe comprising:
a temperature sensor;
a reflector surrounding the temperature sensor and pointing away from a heat source toward a heated surface;
said reflector having and end opening pointing away from the heat source and toward the heated surface, thereby focusing infrared radiation from the heated surface to the temperature sensor; and
an infrared feedback hole in the reflector, thereby allowing some infrared radiation from the heat source to shine directly onto the sensor.

13. In a heated storage container having a top, sides and a bottom, an improvement comprising:
a fluid container in the heated storage container;
said fluid container capable of holding a fluid;
a support for the fluid container;
a support for a wick,
said wick descending into the fluid container;
a lid for the fluid container; and
said lid having a hole to receive the wick; and
said hole being sized to prevent sloshing of the fluid or entry of a pet.

14. A pet enclosure comprising:
a pet container having walls and a bottom;
an ice chest sized to receive the pet container and hold a cold substance;
a heater for the container;
a temperature controller for the heater;
wherein the pet container further comprises an insulated shell;
wherein the heater further comprises an electrically powered heating element;
wherein the temperature controller further comprises a control circuit mounted to a top of the pet container and having a temperature sensor depending from the control circuit into the pet container;
wherein the heater further comprises a cigarette lighter male plug.

15. The apparatus of claim 14, further comprising a house-current to low-voltage power converter having a cigarette lighter female plug.

16. The apparatus of claim 14, wherein the top further comprises a hole sized to accept a housing for the heating element and a temperature sensor.

17. The apparatus of claim 14, wherein the heater comprises:
a sensor;
a heating element comprising a light;
a DC power source;
a power connection for the power source;
a house-current to low-voltage power converter;
a control circuit having circuitry to control the temperature in the container, to sense a sensor out, a heating element out, a power connection out;
an audible alarm to alert a user of any outage; and
an intensity of light emanating from the pet enclosure serves as a visual indication of an intensity of operation of the heater.

18. The apparatus of claim 14, wherein the heating element further comprises a heater grill comprising:
said heater element in a housing;
said housing having fins with a first space between at least one pair of fins opening directly to the heater element;
a grill attachable to the housing;
said grill having at least a pair of fins with a second space therebetween opening directly to the heater element; and
wherein said first and said second space are each sized to restrict an entry of a pet.

19. The apparatus of claim 14, wherein the sensor further comprises:
a temperature probe;
a reflector surrounding the temperature probe and pointing away from a heat source toward a heated surface;
said reflector having an end opening pointing away from the heat source and toward the heated surface, thereby focusing infrared radiation from the heated surface to the temperature sensor; and
an infrared feedback hole in the reflector, thereby allowing some infrared radiation from the heat source to shine directly onto the sensor.

20. The apparatus of claim 14, further comprising:
a fluid container in the heated storage container;
said fluid container capable of holding a fluid;
a support for the fluid container;
a support for a wick;
said wick descending into the fluid container;
a lid for the fluid container; and
said lid having a hole to receive the wick; and
said hole being sized to prevent sloshing of the fluid or entry of a pet.

21. A portable container comprising;
an ice chest having an interior storage area and a flat bottom;
a flange sized to fit on the flat bottom;
an interior box mounted to the flange;
wherein an air space is created between the interior box and the ice chest;
said interior box having a central storage area sized to receive a pet container assembly; and
said pet container assembly further comprising a pet container having a temperature controlled heater.

22. The apparatus of claim 21, wherein the pet container assembly further comprises an outer insulated shell and a removable pet container therein.
